(19) United States
(12) Patent Application Publication
(10) Pub. No.: US 2008/0147366 A1
(43) Pub. Date: Jun. 19, 2008

(54) System and method for displaying simulation data and visualization data

(75) Inventors: Jason Schutz, Orlando, FL (US); Christopher Markuck, Longwood, FL (US)

Correspondence Address: KING & SPALDING LLP (SAIC CUSTOMER NUMBER);ATTN: GEORGE T. MARCOU, 1700 PENNSYLVANIA AVE, NW, SUITE 200, WASHINGTON, DC, 20006, US

(73) Assignee: Science Application International Corporation

(21) Appl. No.: 11/641,015

(22) Filed: Dec. 19, 2006

(51) Int. Cl. G06G 7/72; G06G 7/48

(52) U.S. Cl. 703/8; 703/6

(57) ABSTRACT

Methods and systems for converting simulation data from a first format into a second format thereby allowing the converted data to be overlaid onto imagery data. A simulator, such as OneSAF, generates the simulation data in a first format. An adapter converts the simulation data from the first format into a second format. A imagery system, such as Google Earth, then displays the converted simulation data in the second format over imagery data for the corresponding location.

### FIELD OF INVENTION

The present invention relates to converting data. More particularly, this invention relates to methods and systems for converting simulation data in a first format into a second format and overlaying of the converted simulation data onto imaged terrain.

### BACKGROUND

As the number of satellites increases, the more satellite imagery is becoming available to the public. As a result, satellite imagery systems or image draped systems, such as, Google Earth, are becoming more popular. Using Google Earth, a user can view satellite imagery, 3D terrain, and Geographic Information Services (GIS) data such as roads and political boundaries which can be stored in a central database. Google Earth also allows users to: (a) enter an address and zoom in as if the user was flying, (b) search for different landmarks (such as schools, parks, restaurants, hotels, homes), (c) obtain driving directions, (d) tilt and rotate a view to see 3D terrain and buildings, (e) save and share searches, and (f) add annotations. Using drawing tools, a user can create customized placemarks, shapes, images and overlays. Google Earth can also display information from other sources.

Similar to satellite imagery systems, the number of simulation applications is also increasing. One such application is the U.S. Army's One Semi-Automated Forces (OneSAF) system. OneSAF is a military simulator that represents combined arms tactical operation up to the battalion level. Like many simulators, OneSAF is graphical based rather than image draped based. Graphical based simulators display virtual scene generations rather than “real world” images.

Presently, simulators and imagery systems operate using different protocols and data formats. Thus there is a need to convert simulation data from a first format into a second format that is compatible with an imagery system thereby allowing the converted data to be overlaid onto imaged terrain displayed by the imagery system. Such a display can provide the user of a training exercise to view a simulation in a 3D virtual world and acquire ground truth knowledge and operational pictures.

### SUMMARY OF THE INVENTION

Embodiments of the present invention comprise systems and methods for converting simulation data from a first format into a second format thereby allowing the converted data to be overlaid onto imagery data. In one embodiment, the system comprises a simulator generating simulation data in a first format, an adapter converting the simulation data from the first format into a second format, and an imagery system for generating a display comprising the converted simulation data in the second format onto imagery data. The simulator can be the OneSAF simulator and the imagery system can be Google Earth.

In another embodiment, the method comprises obtaining simulation data in a first format, converting the simulation data into a second format, and providing the converted simulation data to an imagery system for displaying the converted data and imagery data. The method can further include displaying the converted simulation data onto the imagery data.

These exemplary embodiments are mentioned not to limit or define the invention, but to provide examples of embodiments of the invention to aid understanding thereof. Exemplary embodiments are discussed in the Detailed Description, and further description of the invention is provided there. Advantages offered by the various embodiments of the present invention may be further understood by examining this specification.

### BRIEF DESCRIPTION OF THE FIGURES

The present invention will be more clearly understood from a reading of the following description in conjunction with the accompanying exemplary figures wherein:

FIG. 1 is a block diagram of the system components in accordance with an exemplary embodiment of the present invention;

FIG. 2 is a screen shot of supplies of an entity in accordance with an exemplary embodiment of the present invention;

FIG. 3a is a first screen shot of a simulation in accordance with an exemplary embodiment of the present invention;

FIG. 3b is a block diagram of the first screen shot in accordance with an exemplary embodiment of the present invention;

FIG. 4a is a second screen shot of a simulation in accordance with an exemplary embodiment of the present invention;

FIG. 5b is a block diagram of the second screen shot in accordance with an exemplary embodiment of the present invention;

FIG. 5a is a third screen shot of a simulation in accordance with an exemplary embodiment of the present invention;

FIG. 5b is a block diagram of the third screen shot in accordance with an exemplary embodiment of the present invention;

FIG. 6 is block diagram of the adapter and simulator subsystems in accordance with an exemplary embodiment of the present invention;

FIG. 7 is a listing of exemplary KML code;

FIG. 8a is a first screen shot of Google Earth in which simulation data is overlaid over the satellite imagery in accordance with an exemplary embodiment of the present invention;

FIG. 8b is a second screen shot of Google Earth in which simulation data is overlaid over the satellite imagery in accordance with an exemplary embodiment of the present invention;

FIG. 8c is a third screen shot of Google Earth in which simulation data is overlaid over the satellite imagery in accordance with an exemplary embodiment of the present invention; and

FIG. 8d is a fourth screen shot of Google Earth in which simulation data is overlaid over the satellite imagery in accordance with an exemplary embodiment of the present invention.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be limiting, but merely as a basis for the claims and as a representative basis for teaching one skilled in the art to variously employ the present invention. Reference is now made in detail to the preferred embodiments of the present invention, examples of which are illustrated in the accompanying drawings.

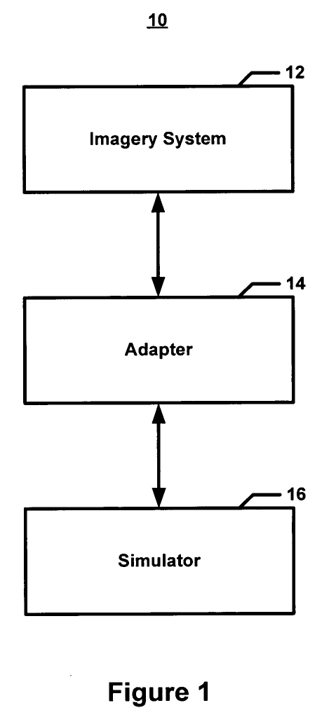

Referring to FIG. 1, a block diagram of the system components in accordance with an exemplary embodiment of the present invention is illustrated. The system 10 converts simulation data in a first format into a second format that allows the converted data to be overlaid onto imaged terrain. The system 10 can comprise three main components: imagery system 12, adapter 14, and simulator 16. As shown, the imagery system 12, adapter 14, and simulator 16 are separate components, however in alternate embodiments, one or more components can be combined. For example, the adapter 14 can be part of the imagery system 12, the adapter 14 can be part of the simulator 16, or the imagery system 12, adapter 14, and simulator 16 can be combined into one component. The simulator 16 generates simulation data in a first format. The adapter 14 converts the simulation data from the first format into a second format that is compatible with the imagery system 12. The imagery system 12 displays the converted simulation data by overlaying the converted data onto imaged terrain. Thus, the system 10 is able to display the simulation data in an enhanced 3D environment displaying satellite imagery.

The simulator 16 can generate actual or operational conditions, such as flying, driving, and tactical (e.g., war scenarios) between entities or objects. Preferably, the simulator 16 is an internet based system. In a preferred embodiment, the system 10 can operate using a distribution protocol thereby allowing one or more simulators 12 to be run at the same time. The simulators 12 can be located at different nodes of the network, such as the Internet or a Local Area Network (LAN). In alternate embodiments, the simulator 16 can be a stand alone system, e.g., a program that is loaded onto a server, computer, and/or a dedicated system.

The simulator 16 generates simulation data in a first format, such as Distributed Interactive Simulation (DIS) or High Level Architecture (HLA). The simulation data is saved where it can be accessed by the simulator 16 and/or the adapter 14. In a preferred embodiment, the simulator 16 is a OneSAF simulator, which can simulate tactical scenarios between entities (e.g., airplanes, helicopters, unmanned aerial vehicles (UAV), ground vehicles, water vessels, mortars, troops) and provide status information (e.g., location, velocity, headings) for the entities.

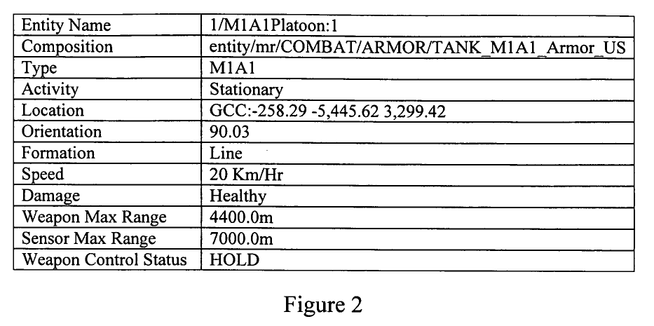

Referring to FIG. 2, an exemplary table listing status parameters of an entity is illustrated. As shown, the status of the entity includes an entity name, composition, type, activity, location, orientation, formation, speed, damage, weapon max range, sensor max range, and weapon control status.

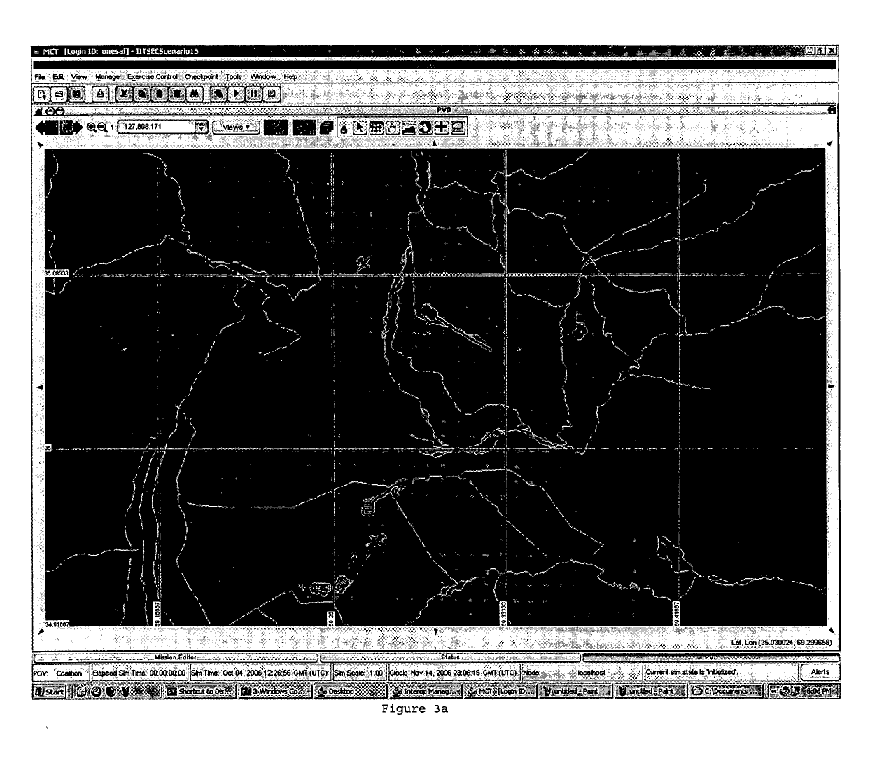

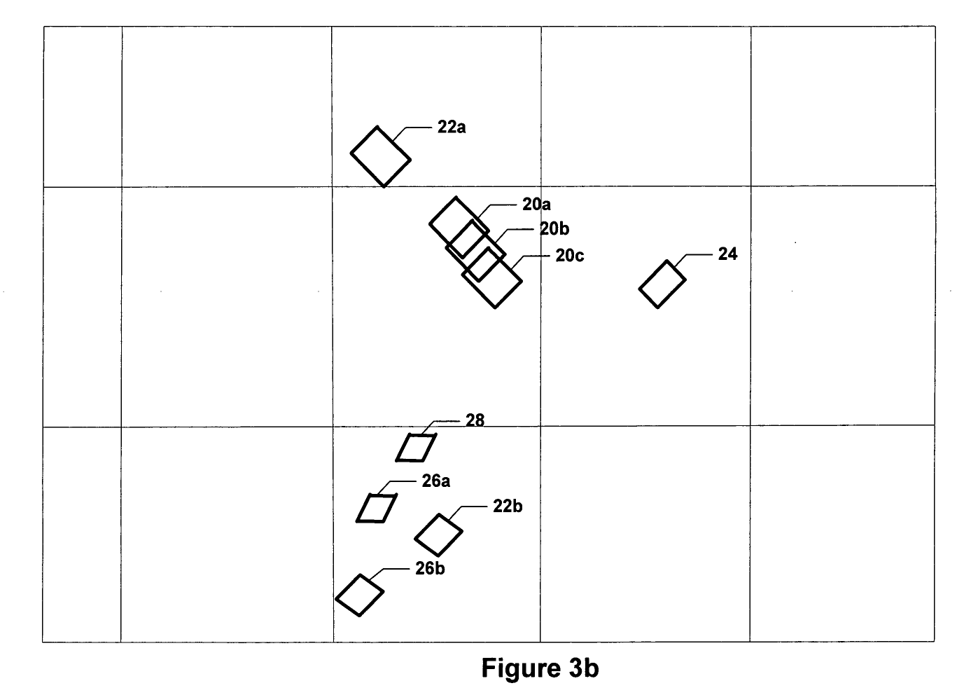

Referring to FIGS. 3a and 3b, a first screenshot of a simulation and a first block diagram which is substantially the same as the first screen shot, respectively, in accordance with an exemplary embodiment of the present invention are illustrated. As shown in these figures, a convoy of three vehicles 20a, 20b, 20c are heading southeast (due to the resolution only one vehicle is shown in FIG. 3a). An unmanned aerial vehicle (UAV, e.g. a drone) 22a is flying towards the three vehicles. East of the vehicles 20a, 20b, 20c, a rocket launcher 24 is positioned to attack an airfield. South of the vehicles 20a, 20b, 20c, a mortar 28 is about to fire rounds at the airfield, where an F/A 18 22b and Strykers 26a, 26b are simulated.

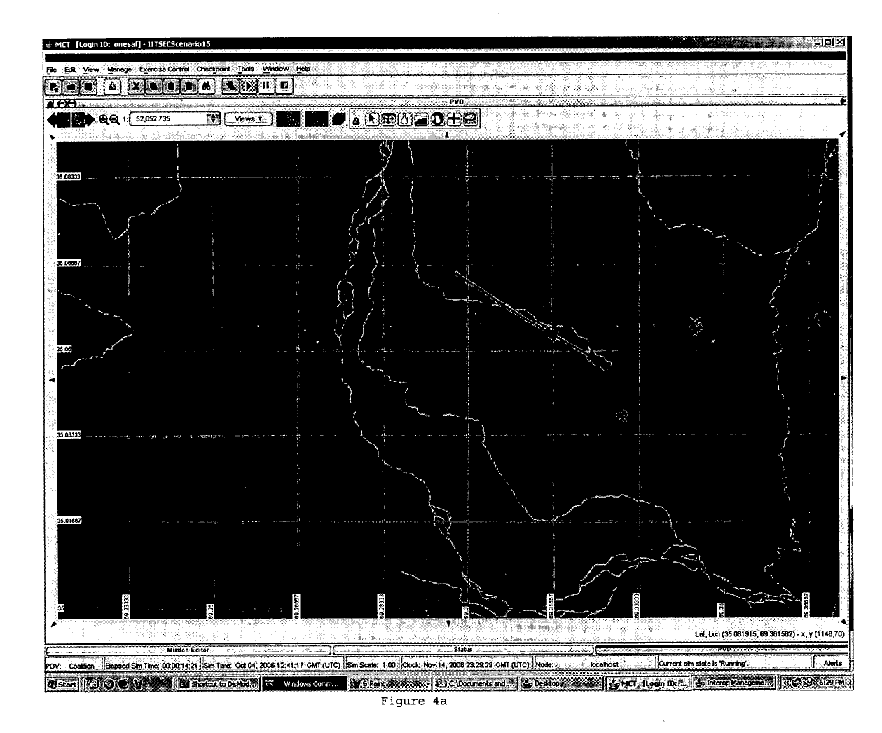

Referring to FIGS. 4a and 4b, a second screenshot of the simulation and a second block diagram which is substantially the same as the second screen shot, respectively, in accordance with an exemplary embodiment of the present invention are illustrated. The events in FIGS. 4a and 4b occur shortly after the events in FIGS. 3a and 3b and the user has zoomed in on the northern skirmish or encounter. As shown, one vehicle 20a has been hit (as illustrated in FIG. 4b with an “X”) and the other two vehicles 20b, 20c are continuing to move in a southeastern direction. The rocket launcher 24 has also been hit (as illustrated in FIG. 4b with an “X”). F/A18s 22b, 22c are about to engage vehicles 20b, 20c.

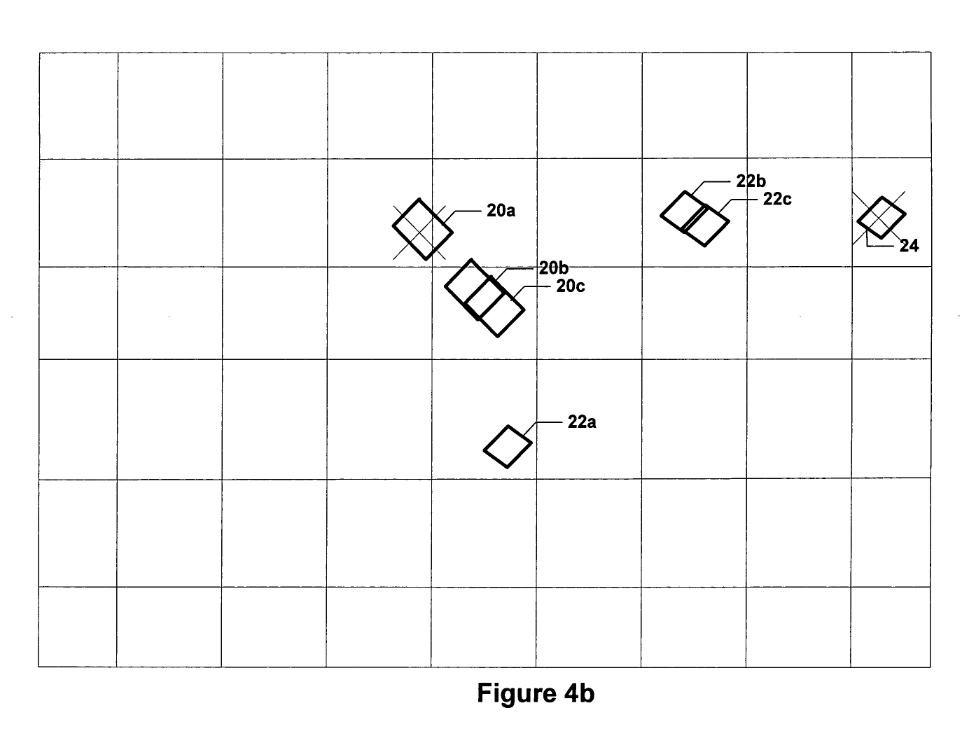

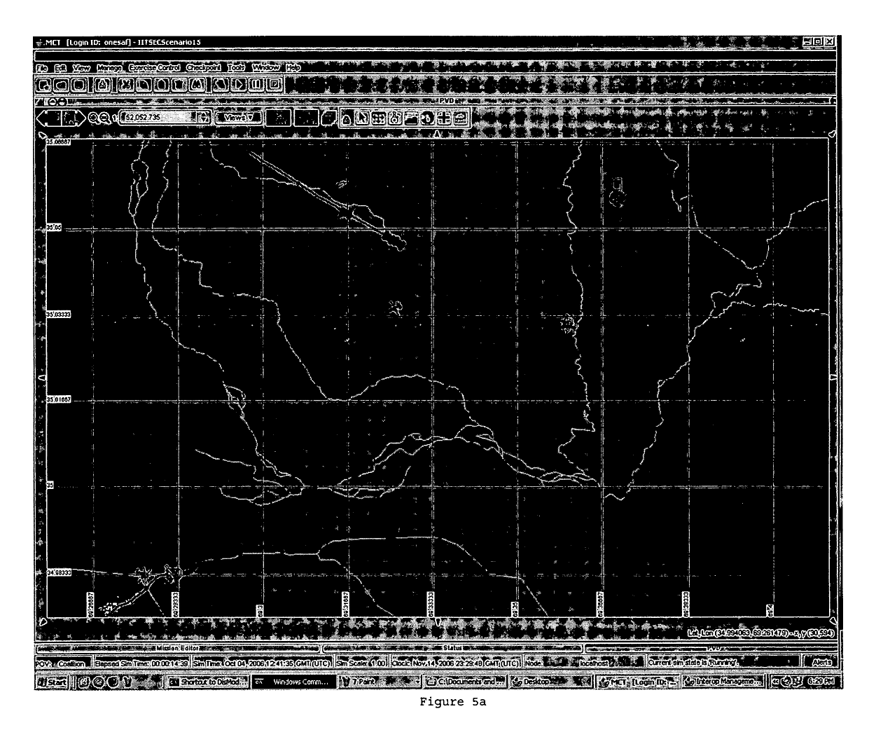

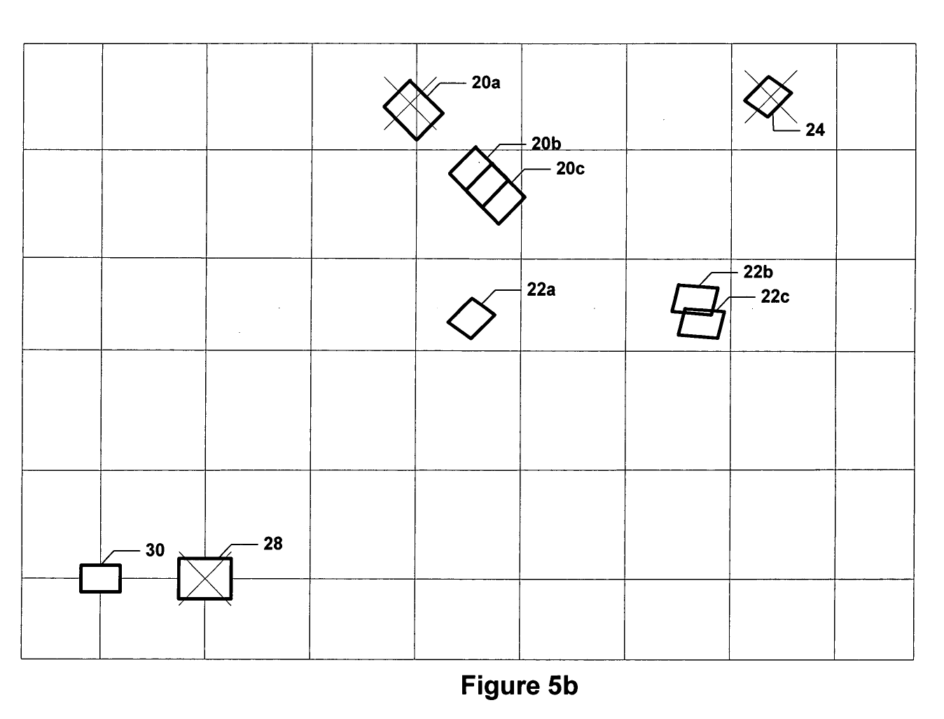

Referring to FIGS. 5a and 5b, a third screenshot of the simulation and a third block diagram which is substantially the same as the third screen shot, respectively, in accordance with an exemplary embodiment of the present invention are illustrated. The events in FIGS. 5a and 5b occur shortly after the events in FIGS. 4a and 4b and the user has panned out to show the first and second skirmishes. In the northern skirmish, a UAV 22a continues to head southwest with the other two F/A18s 22b, 22c heading towards the two vehicles 20b, 20c. In the southern skirmish, a helicopter 30 is flying over the mortar 28 which was hit (as illustrated in FIG. 5b with an “X”).

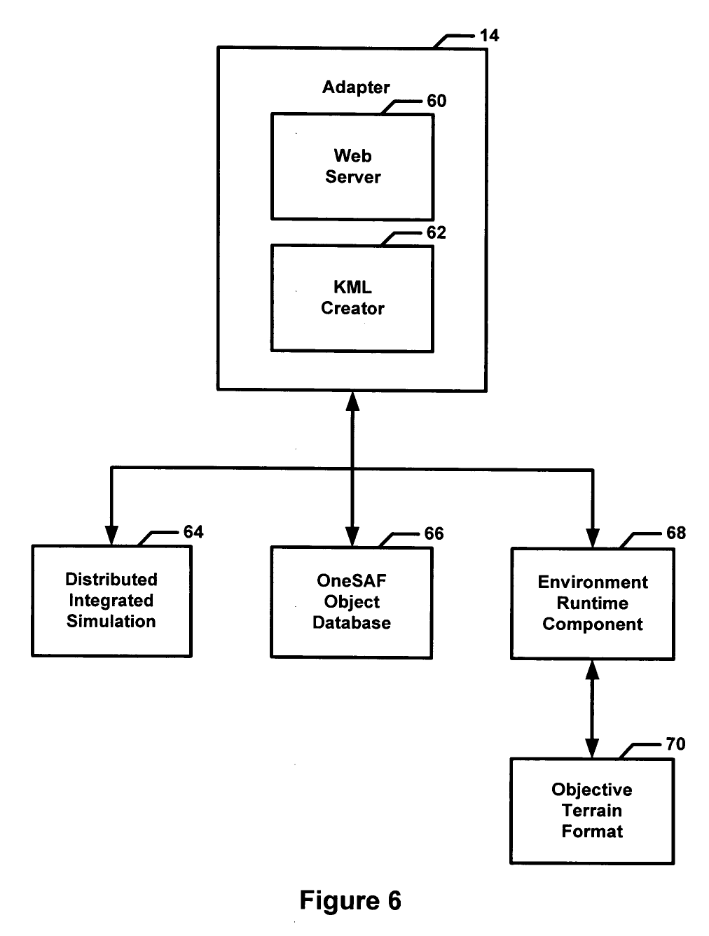

Referring to FIG. 6, a block diagram of the adapter and simulation subsystem in accordance with an exemplary embodiment of the present invention is illustrated. As shown, the simulator 16 can include a DIS subsystem 64, OneSAF Object Database (ODB) subsystem 66, Environment Runtime Component (ERC) subsystem 68 and Objective Terrain Format subsystem 70. As shown, each of these components 64, 66, 68, 70 are separate components, however in alternate embodiments, one or more components can be combined. Each component 64, 66, 68, 70 can be stored at one or more locations on a network, e.g., nodes on a network such as the Internet or a LAN. In alternate embodiments, the adapter 14 can be a stand alone system, e.g., a program that is loaded onto a server, computer, and/or a dedicated system. All users who access the adapter 14 can be required to have a username and password specified by the system 10. Properly authorized users can control a simulation.

The DIS subsystem 64 can control the distribution of information regarding the simulation across one or more nodes of a network. Such information can include simulation control, entity status, weapon firing, movement, velocity. Simulation control controls the simulator, e.g., starting, stopping, movement of objects, etc. Entity status can include the location of an entity (e.g., an object) within a simulation, and the status of the weapons, e.g., firing of the weapons. The ODB subsystem 66 stores data for the simulated objects, and can include object information such as vehicles, routes, and orders. The ERC 68 can provide the environment for a given simulation, e.g. synthetic environment. The synthetic environment provides terrain data such as the location of roads, buildings, and terrain elevation. The terrain data can be stored in the OTF terrain component 70.

Referring back to FIG. 6, the adapter 14 can comprise two components: a web server 60 and a KML (Keyhole Markup Language) creator 62. In alternative embodiments, the KML creator 62 can be part of the simulator 16. The adapter 14 can retrieve the simulation data by reading stored files, listening to the simulator 16, e.g., monitoring for data which is exported from the simulator 16, and/or querying the simulator 16 directly. The adapter 14 can interface with the ODB 66 to pull information regarding the simulation including simulation status, entity status, and reports. The adapter 14 can have limited control over one or more simulations, e.g., starting, stopping, and pausing the simulation. The adapter 14 provides the converted simulation data to the imagery system 12 via the web server 60. The adapter 14 can provide the converted simulation data to multiple client imagery systems 12 for displaying.

The KML creator 62 can be the interface between the Web server 60 and the simulator 12, and more specifically the interface to the simulator subsystems 64, 66, 68, 70. When a request for data is received by the Web server 60 the request is forwarded to the KML creator 62 to retrieve the appropriate information from the simulation data. This information can be imported or sent over a network link to the imagery system 12 by utilizing the KML data format. The KML creator 62 converts the simulation data from a first format, such as Distributed Interactive Simulation (DIS), to a second format, such as KML. The KML creator 62 creates a file, preferably a KML file, containing the requested data. KML is a language for describing data inside of the imagery system 12. Using KML, icons with labels, e.g., placemarks, can be created at specific geodetic locations. In alternate embodiments, other creators 62 can be used to convert the simulation data into a format compatible with the imagery system 12.

The Web server 60 uses the Hypertext Transfer Protocol (HTTP) to provide requested files to the imagery system 12 using a Web page generator in combination with the KML creator 62 thereby creating dynamic responses. The Web server 60 can provide real-time access to all simulation information such as the status of all the nodes in the distribution (simulation state, object load, capability, memory usage, etc.). Entity information is enhanced by being able to provide weapon status, sensor/weapon range and supply status of the selected entity (see, e.g., FIG. 2). Reports generated by the simulator 16 such as Observation reports can also be viewed through the Web interface.

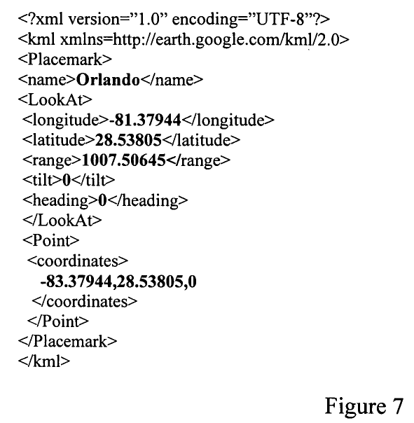

The Web server 60 and the imagery system 12 exchange requests and files via one or more network links, preferably via one or more KML NetworkLinks using KML files or compressed or zipped KML files (KMZ files). Referring to FIG. 7, an exemplary KML file is illustrated. This request can contain specific information in the HTTP request string regarding the type of KML data required. The adapter 14 can retrieve data from the simulation data and convert the data for displaying.

The adapter 14 provides converted simulation data to the imagery system 12. The converted data can be custom icons and/or placemarks representing specific entity including entity types, entity movement, fire events, or detonation events, from the simulation events. The converted data can be in a file specifying a set of features (placemarks, images, polygons, 3D models, textual descriptions, etc.). The set of features can include longitude and latitude information, as well as tilt, heading, altitude, which together can define a “camera view.” Each placemark references a certain icon style. Each icon style then references an icon file. The icon file can be accessed from one or more sources, such as a local disk drive, from inside a zipped or compresses file, or directly accessed from the Web server using a uniform resource locator (URL), e.g., through a webpage.

The imagery system 12 allows the converted simulation data to get updated dynamically by using a network link. There are a few different types of network links that can be utilized. For instance, the simulated entities can have a network link providing periodic updates, thus entity movements can be displayed. Separate network links can then be used to update different entity platform types at different intervals. A network link can be used to update static information using either a one-time update or a region-based update. The region-based update sends the information about the camera location and orientation to the Web server 60 as part of the request. The Web server 60 can then resend the converted simulation data for the new view.

The adapter 14 can use a second network link to introduce updates to the converted simulation data loaded from the first network link. This can allow new placemarks and geometries to be created in the original converted simulation data or changes to existing converted simulation data. Finally, it is possible to delete data from the original converted simulation data. All this is possible without refreshing all of the original converted simulation data.

The KML creator 62 can also produce converted simulation data representing features in the user's current view. A bounding box network link can be used to accomplish this task. When the user of the imagery system 12 repositions the camera view, the network link can send an HTTP request for the features in the new view. The KML creator 62 can then produce the KML of the features for the current view.

A more advanced technique for refreshing KML data based on a view has been introduced in KML version 2.1. Level-of-detail (LOD) support in KML 2.1 can allow multiple levels of network links for specific regions of the terrain. For example, a 1 degree by 1 degree image overlay can be partitioned into four equal sized boxes. Each of the four boxes can have a separate network link to download the KML data of an image overlay for itself when the viewer is close enough to the box. The downloaded KML for the box will also have four more network links for an additional four smaller boxes.

In a preferred embodiment, the imagery system 12 is Google Earth. In alternative embodiments, other imagery systems 12 can also be used, such as, Microsoft Virtual Earth™, two-dimensional Google Maps, three-dimensional NASA World Wind, and three-dimensional Environmental Systems Research Institute, Inc. (ESRI) ArcGIS Explorer. Microsoft Virtual Earth and Google Maps can require Internet access to download terrain imagery; however these systems can allow for direct manipulation of objects on a map. NASA World Wind is an open source system. As with Google Earth, ESRI ArcGIS Explorer can use KML data, along with data from ArcGIS Server.

Google Earth is a terrain imagery application that provides a virtual globe of the Earth and provides the user with the ability to freely move around in a virtual environment by changing the viewing angle and position. Compared to a conventional globe, virtual globes have the additional capability of representing many different views on the surface of the earth. These views may be of geographical features, man-made features such as roads and buildings or abstract representations of demographics quantities such as population. Google Earth can also provide Geographical Information Services (GIS) data such as political boundaries. Using drawing tools in the application, a user can create customized placemarks, shapes, images, and overlays.

The adapter 14 provides the converted simulation data to the imagery system 12 for displaying to a user. Preferably, the converted simulation data is displayed as placemarks or icons being overlaid over a Google Earth map. Specifically, the converted simulation data overlaid over a corresponding Google Earth map based on the location data associated with the converted simulation data. The imagery system 12 can download terrain imagery and elevation data from the Internet on demand for real-time display and/or can use data that has been stored in memory. In a preferred embodiment, the imagery system 12 can use proprietary, non-disclosed terrain data rather than the default terrain provided by the imagery system 12.

The imagery system 12 can include an embedded Web browser that can be used to display HTML pages. The adapter 14 utilizes this functionality to serve HTML pages with the current status of the simulation (Idle, Simulating, Playback, etc.), the status of simulated entities (weapon status, damage, speed, location, orientation), to provide an interface to control the adapter 14 and control of the imagery system 12. The Web page generator can utilize AJAX (Asynchronous JavaScript and XML) to provide periodic updating of the converted simulation data. The converted simulation data can be updated behind the scenes so updates can appear to be instantaneous to the user. The imagery system 12 can download terrain imagery and elevation data via the Internet on demand. The imagery system 12 can display the converted simulation data over the downloaded terrain imagery, thereby making custom maps.

Google Earth can use “COLLAborative Design Activity” (COLLADA) models to perform the 3D transformation of the converted simulation data. COLLADA is a Collaborative Design Activity for establishing an interchange file format for interactive 3D applications. COLLADA defines an open standard XML schema for exchanging digital assets among various graphics software applications that might otherwise store their assets in incompatible formats. COLLADA documents that describe digital assets are XML files, usually identified with a .dae (Digital Asset Exchange) filename extension. KML is based on XML, and follows XML syntax rules.

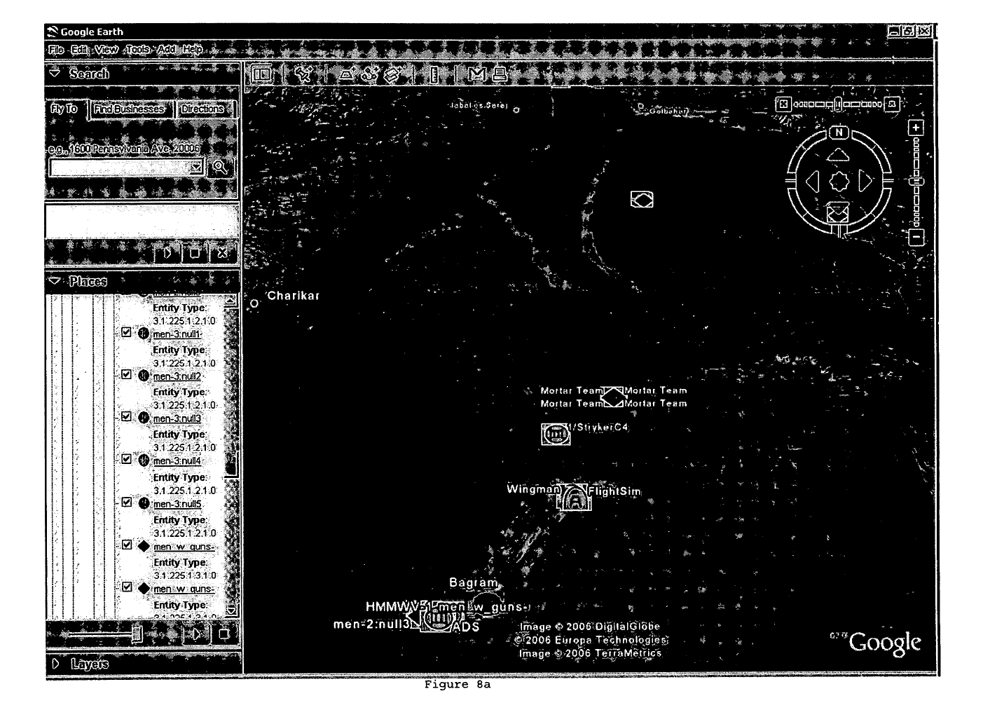

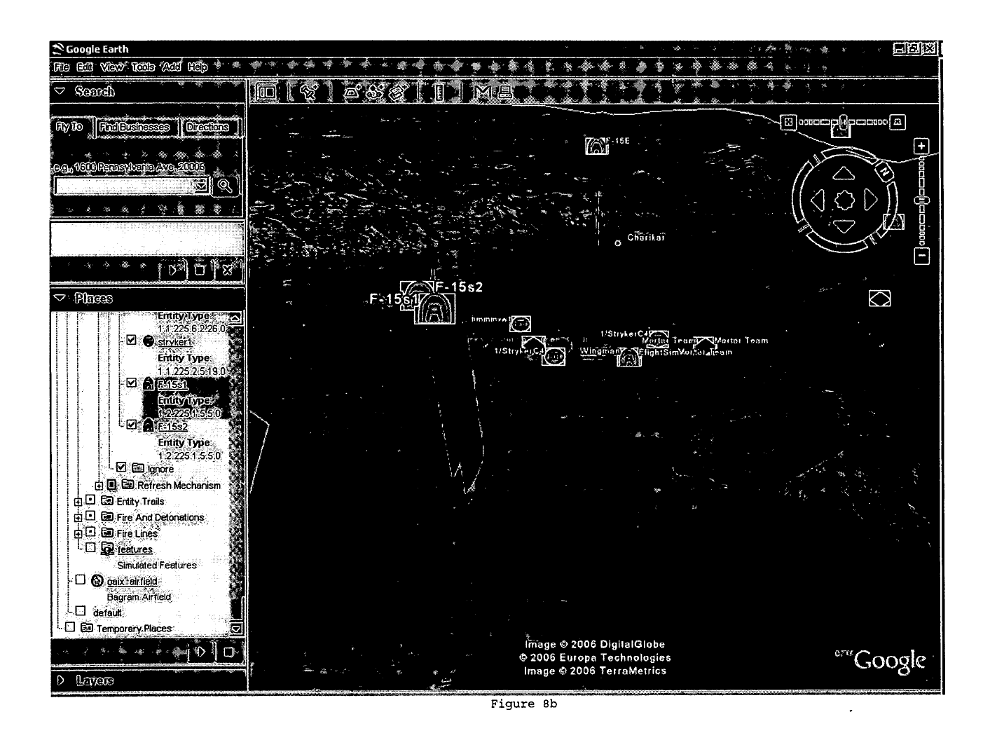

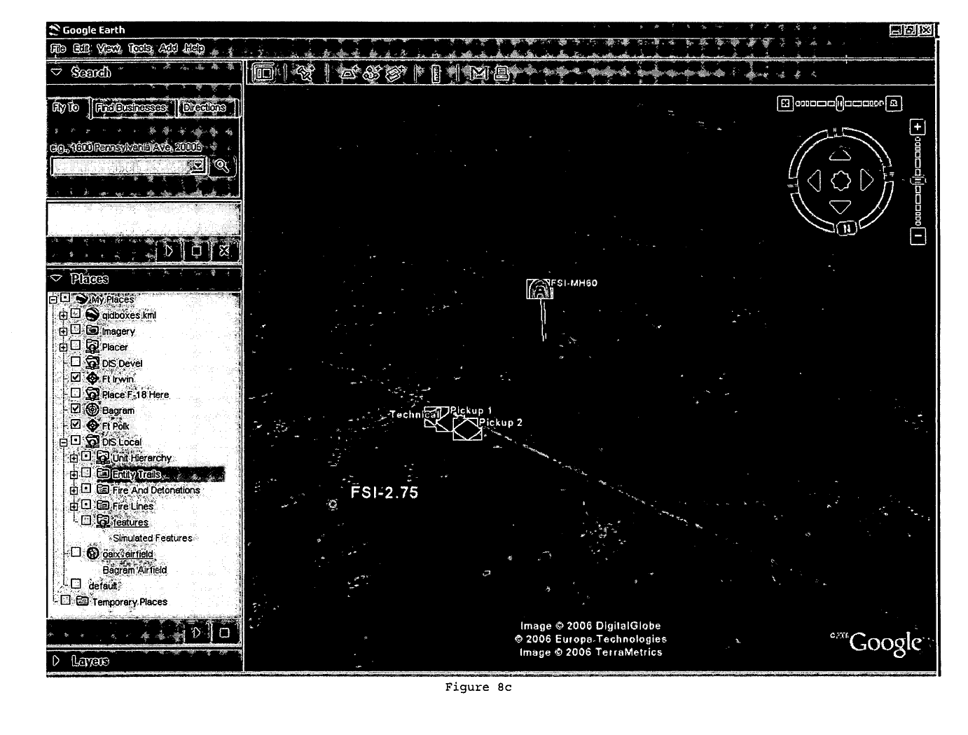

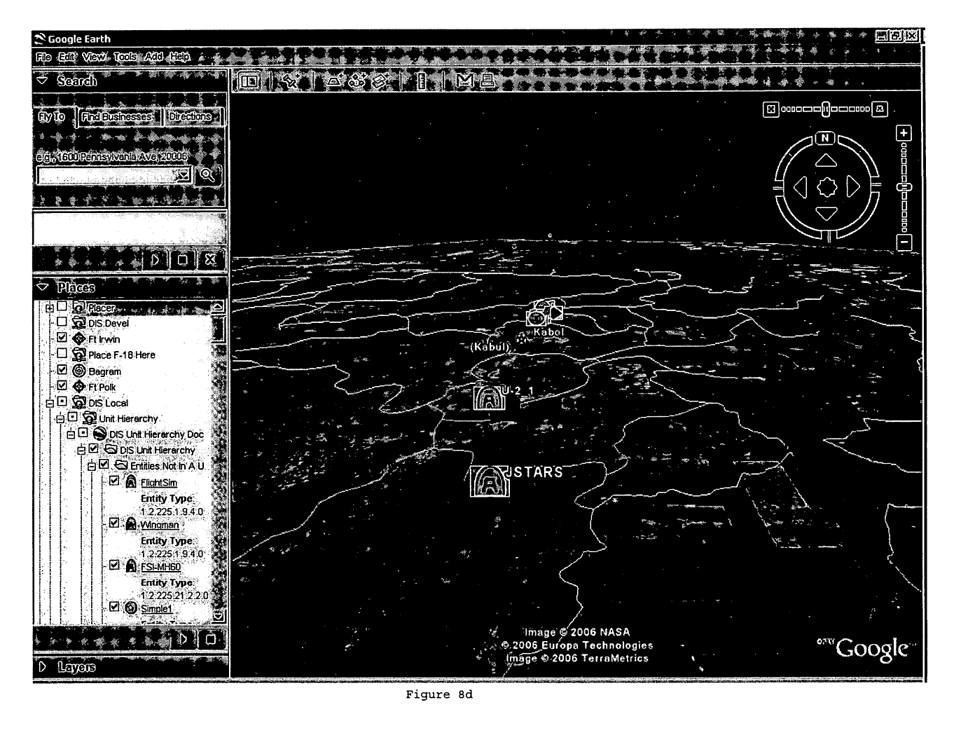

Referring to FIGS. 8a-8e screenshots of Google Earth in which simulation data is overlaid over the satellite imagery are illustrated in accordance with exemplary embodiments of the present invention are illustrated. As shown in FIG. 8a, the imagery terrain is a mountainous area with some trees in Afghanistan. The system 10 is displaying key landmarks such as Bagram Airbase and cities such as Charikar, JabalosSaraj, and Golbahar. In addition, military entities are shown as well, for example, HMMWV, Wingman, FlightSim, 1/StrykerC4, and mortar teams are shown. The system 10 is displaying the icons for each of these entities in the approximate position of each based on the simulation data. As shown in FIG. 8b, the same icons are shown but from a different angle, e.g., the image is rotated. The screens in OneSAF cannot be rotated in this manner, thus an advantage of the system 10 is the ability that a user can rotate the simulation. On the left sided of this screenshot, options for the simulation are shown. For this screenshot, entity trails, fire and detonations, and fire lanes are checked thereby indicating that these features are to be shown. As shown, each of the airplanes includes an entity trail indicating the path the airplane has taken.

Referring to FIG. 8c, a screenshot of a skirmish is shown with the vehicles, e.g., Pickup 1 and Pickup 2 firing at the helicopter FSI-MH60. In addition to the entities, the trajectories of the missiles and the locations of the detonations are shown as icons. During this simulation, one missile has yet to detonate. Referring to FIG. 8d, another screenshot of the skirmish is shown with the flight pattern of an attacking airplane being shown. Specifically, the firing of weapons (as illustrated by the plane icon, the firing lines (the funnel shape starting in the northeast and heading southwest), and the detonations (the stars) are shown in which the airplane was attempting to destroy the technical target. Referring to FIG. 8e, a screenshot of the entities at about the horizon are illustrated. Two of the entities are identified, e.g., U-2_{—}1 and JSTARS. In addition, the city of Kabol is marked along with the borders of the countries.

The foregoing description of the preferred embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

What is claimed is:

1. A computer implemented system comprising:
a simulator generating simulation data in a first format;
an adapter converting the simulation data from the first format into a second format; and
an imagery system for generating a display comprising the converted simulation data in the second format onto imagery data.

2. The computer implemented system of claim 1 wherein the simulator is OneSAF.

3. The computer implemented system of claim 1 wherein the first format is one of Distributed Interactive Simulation (DIS) and High Level Architecture (HLA).

4. The computer implemented system of claim 1 wherein the adapter comprises a web server and a Keyhole Markup Language (KML) creator.

5. The computer implemented system of claim 1 further comprising one or more network links to provide the converted simulation data in the second format to the imagery system.

6. The computer implemented system of claim 1 wherein the imagery system is a three dimensional imagery system.

7. The computer implemented system of claim 1 wherein the imagery system is Google Earth.

8. The computer implemented system of claim 1 wherein the imagery system is one of Microsoft®t Virtual Earth™, two-dimensional Google Maps, three-dimensional NASA World Wind, and three-dimensional Environmental Systems Research Institute, Inc (ESRI) AreGIS Explorer.

9. The computer implemented system of claim 1 wherein the simulation data includes data associated with at least one entity.

10. The computer implemented system of claim 9 wherein the at least one entity is one of an airplane, helicopter, unmanned aerial vehicle, ground vehicle, water vessel, and troops.

11. A method comprising:
obtaining simulation data in a first format;
converting the simulation data into a second format; and
displaying the converted simulation data and imagery data.

12. The method of claim 11 further comprising generating simulation data using a simulator.

13. The method of claim 12 wherein the simulator is OneSAF.

14. The method of claim 11 wherein the first format is one of Distributed Interactive Simulation (DIS) and High Level Architecture (HLA).

15. The method of claim 11 wherein the converted data is overlaid onto the imagery data.

16. The method of claim 11 further comprising communicating the converted simulation data in the second format to the imagery system via one or more network links.

17. The method of claim 11 wherein the imagery system is a three dimensional imagery system.

18. The method of claim 11 wherein the imagery system is Google Earth.

19. The method of claim 11 wherein the imagery system is one of Microsoft® Virtual Earth™, two-dimensional Google Maps, three-dimensional NASA World Wind, and three-dimensional Environmental Systems Research Institute, Inc (ESRI) AreGIS
Explorer.

20. A system comprising:
a OneSAF simulator generating simulation data in Distributed Interactive Simulation (DIS) format;
an adapter converting the simulation data form the DIS format into a Keyhole Markup Language (KML) format; and
a Google Earth imagery system for displaying the converted simulation data onto imagery data, wherein the converted simulation data is overlaid onto the imagery data.
